(19) United States
(12) Patent Application Publication
(10) Pub. No.: US 2012/0259674 A1
(43) Pub. Date: Oct. 11, 2012

(54) SYSTEMS AND METHODS FOR PROVIDING MARKET INSIGHT

(75) Inventors: Bradley M. Cantwell, Chicago, IL (US); David R. Heath, Katy, TX (US); Christa D. Manning, Scituate, MA (US); Frank Schnur, JR., Hopkinton, MA (US)

(73) Assignee: American Express Travel Related Services Company, Inc., New York, NY (US)

(21) Appl. No.: 13/080,575

(22) Filed: Apr. 5, 2011

(51) Int. Cl. G06Q 30/00

(52) U.S. Cl. 705/7.29

(57) ABSTRACT

The present disclosure includes a system, method, and article for providing market insight. The system may generate a market profile based upon actual purchase data. The market profile may include one or more of the following: a pricing trend, a high price, a low price, an average price, a median price, a mean price, a modal price, a most frequently paid price, an optimal date to make a purchase, an optimal date to redeem a purchase, an optimal merchant from which to purchase, and an optimal location to make a purchase. The system may further transmit the market profile to a client.

### BACKGROUND

1. Field of the Invention

The present disclosure generally relates to providing market insight data.

2. Related Art

Consumers often decide on purchases based upon incomplete data. For instance, consumers preparing for a purchase frequently select an item for purchase (e.g., travel tickets) based upon their perception of a fair price or average price. In another example, consumers preparing for a purchase often fall victim to the same type of perception-based thinking by purchasing based upon little or no actual data about what merchants are currently charging others and/or what merchants have recently been charging.

Systems have been developed to assist consumers in making educated purchasing decisions. For example, some websites use historical pricing to predict the purchase price of a particular travel fare in the future. Other websites may offer a service that shows an average price associated with a variety of hotels, flights, rental cars, etc. While such websites may utilize historical data as a basis for generating (average) pricing trends, such services often rely upon published price data, as opposed to actual booked price data. As a result of this approach, such services may actually effect changes in the published prices of hotel rooms and airline fares because, for example, certain airlines and/or hotel chains adjust their published prices based upon interest therein (e.g., as “click through” increases, the published prices increase).

Therefore, a system for predicting pricing trends that does not drive (or minimizes driving) prices higher as consumers search for deals is needed. Further, a system that is capable of looking at actual price data, as opposed to published price data, is needed. Further still, a system that reviews not only historical booked price data, but also future booked price data is needed, as such a system will improve the predictions generated by the system.

### SUMMARY

The present disclosure includes a system, method, and article for providing market insight data. To this end, the system may generate a market profile based upon actual purchase data. The market profile may include one or more of the following: a pricing trend, a high price, a low price, an average price, a median price, a mean price, a modal price, a most frequently paid price, an optimal date to make a purchase, an optimal date to redeem a purchase, an optimal merchant from which to purchase, and an optimal location to make a purchase. The system may further transmit the market profile to a client. The system may also generate the market profile based upon published pricing data. The actual purchase data may comprise future booked purchase data and/or may occur within a range.

### BRIEF DESCRIPTION OF THE DRAWINGS

The features and advantages of the present disclosure will become more apparent from the detailed description set forth below when taken in conjunction with the drawings, wherein like numbers refer to like elements.

FIG. 1 shows an exemplary system diagram, in accordance with an embodiment.

FIG. 2 shows a flowchart depicting an exemplary method for providing market insight.

FIG. 3A shows an exemplary market profile and market profile tool.

FIG. 3B shows an exemplary market profile and market profile tool.

FIG. 3C shows an exemplary market digest portion of a market profile and market profile tool.

### DETAILED DESCRIPTION

The detailed description of exemplary embodiments herein makes reference to the accompanying drawings, which show the exemplary embodiments by way of illustration and their best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Phrases and terms similar to “financial institution,” “transaction account issuer,” and “payment processor” may include any person, entity, software and/or hardware that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business”, “merchant”, “supplier” or “seller” may be used interchangeably with each other and shall mean any person, entity, distributor system, software and/or hardware that is a provider, broker and/or any other entity in the distribution chain of goods or services and/or that receives payment or other consideration. For example, a merchant may be a grocery store, a retail store, a travel agency, a service provider, an on-line merchant or the like. For example, a supplier may request payment for goods sold to a buyer who holds an account with a transaction account issuer.

The terms “payment vehicle,” “financial transaction instrument,” “transaction instrument,” “transaction account product” and/or the plural form of these terms may be used interchangeably throughout to refer to a financial instrument. As used herein, an account code may or may not be associated with a physical financial instrument.

Phrases and terms similar to a “buyer,” “consumer,” and “user” may include any person, entity, software and/or hardware that receives items in exchange for consideration (e.g. financial payment). For example, a buyer may purchase, lease, rent, barter or otherwise obtain items from a supplier and pay the supplier using a transaction account.

Phrases and terms similar to an “item” may include any good, service, information, experience, reward, points, coupons, credits, monetary equivalent, anything of value, something of minimal or no value, etc.

Phrases or terms similar to a “processor” (such as a payment processor) may include a company (e.g., a third party) appointed (e.g., by a merchant) to handle transactions for merchant banks. Processors may be broken down into two types: front-end and back-end. Front-end processors have connections to various transaction accounts and supply authorization and settlement services to the merchant banks' merchants. Back-end processors accept settlements from front-end processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases or terms similar to a “payment gateway” or “gateway” may include an application service provider that authorizes payments for e-businesses, online retailers, and/or traditional brick and mortar merchants. A payment gateway may protect transaction account details by encrypting sensitive information, such as transaction account numbers, to ensure that information passes securely between the customer and the merchant and also between merchant and payment processor.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

Phrases or terms similar to “transaction account” may include any account that may be used to facilitate a financial transaction. A “transaction account” as used herein refers to an account associated with an open account or a closed account system (as described herein). The transaction account may exist in a physical or non-physical embodiment. For example, a transaction account may be distributed in non-physical embodiments such as an account number, frequent-flyer account, and telephone calling account or the like. Furthermore, a physical embodiment of a transaction account may be distributed as a financial instrument.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

An “account”, “account code”, or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

The account code may be distributed and stored in any form of plastic, electronic, magnetic, radio frequency, wireless, audio and/or optical device capable of transmitting or downloading data from itself to a second device. A customer account code may be, for example, a sixteen-digit transaction account code, although each transaction account provider has its own numbering system, such as the fifteen-digit numbering system used by American Express. Each company's transaction account codes comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account code may be, for example, any number or alpha-numeric characters that identify a particular merchant for purposes of card acceptance, account reconciliation, reporting, or the like.

It should be noted that the transfer of information in accordance with the present disclosure, may be completed in a format recognizable by a merchant system or account issuer. In that regard, by way of example, the information may be transmitted from an RFID device to an RFID reader or from the RFID reader to the merchant system in magnetic stripe or multi-track magnetic stripe format.

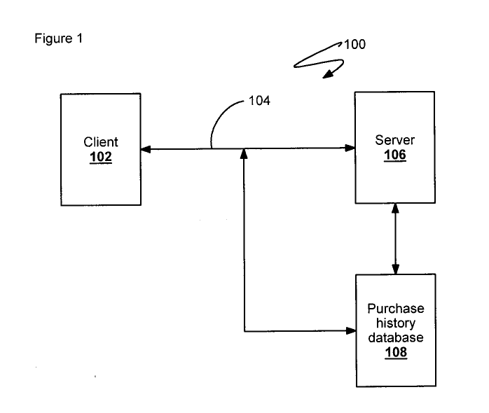

Referring to FIG. 1, system 100 implements a method for generating market insights. System 100 may include a client 102, a network 104, a server system 106, and a purchase history database 108. System 100 may include a variety of other components, including, for example, one or more mobile gateway servers (not shown) for securely receiving and transmitting data to and from the client 102, one or more electronic commerce website servers (not shown), and/or one or more payment processor authorization gateway servers (not shown).

Client 102 may comprise any software and/or hardware suitably configured for sending and/or receiving data. Client 102 may include a personal computer such as a desktop or laptop computer, an iPad, iMAC, MacBook, or generally any of a wide array of personal computing products. Client 102 may further comprise a kiosk, a terminal, a point of sale (POS) device, a television, a digital sign or banner, or any other device capable of sending and/or receiving data over a network. In an embodiment, client 102 may run Microsoft Internet Explorer, Mozilla Firefox, Google Chrome, Apple Safari, or any other of the myriad software packages available for browsing the internet. Client 102 may further comprise, at least, a display, such as a liquid crystal display (LCD), or a plasma screen display. Client 102 may further comprise a mobile communication device, such as a smart phone (e.g., an iPhone, Blackberry, Droid device, and/or the like) and/or a personal digital assistant (PDA).

Network 104 may comprise software and/or hardware suitably configured or configurable to facilitate the transmission and reception of data. Thus, network 104 may comprise any of a variety of wired and/or wireless network architectures, including, for example, an RF network architecture such as a network associated with a wireless provider (e.g., a 3G or 4G network), a Wi-Fi network architecture (e.g., a home area or local area network), and/or a wired network architecture reliant upon one or more cables and/or trunk lines and/or optical fibre lines.

Server system 106 may comprise software and/or hardware suitably configured or configurable to receive and/or process data. Thus, server system 106 may comprise a rack mountable server appliance running a suitable server operating system (e.g., IIS) and having database software (e.g., Oracle) installed thereon.

Purchase history database 108 may comprise any type of computer server configured or configurable to host a database. In an embodiment, such a server comprises a rack mountable server appliance running a suitable server operating system (e.g., IIS) and having database software (e.g., Oracle) installed thereon. In an embodiment, purchase history database 108 may host a database comprising booked purchase price data and/or published pricing data.

Client 102 may be coupled to server system 106 by way of network 104. Likewise, server system 106 may be coupled to purchase history database 108 by way of network 104. Thus, client 102 may receive (processed or raw) data from purchase history database 108 through server system 106. In an embodiment, client 102 may receive data directly from purchase history database 108; this may be accomplished by way of network 104. In this embodiment, client 102 may process data in a manner or based on an algorithm that server system 106 may be configured to implement in an embodiment.

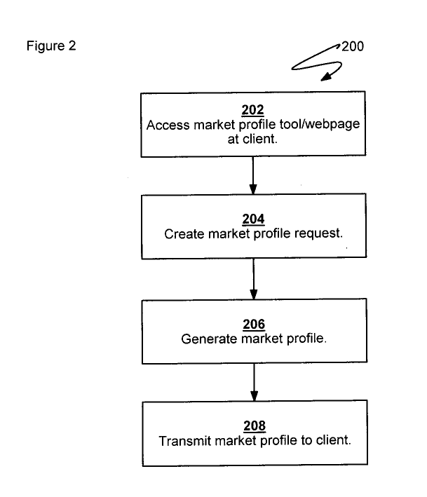

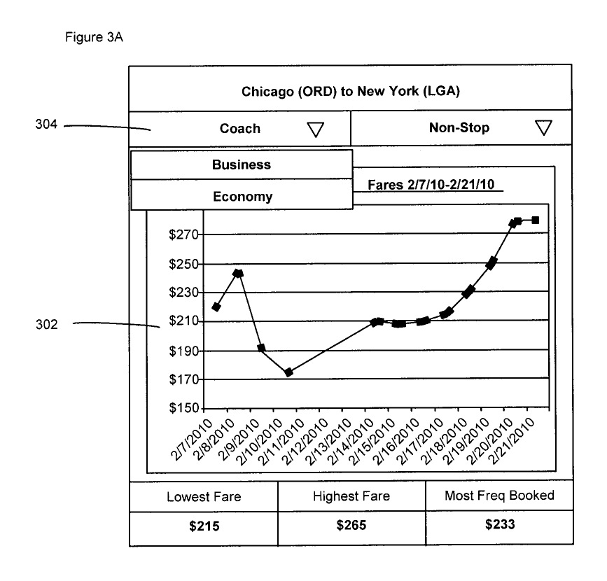

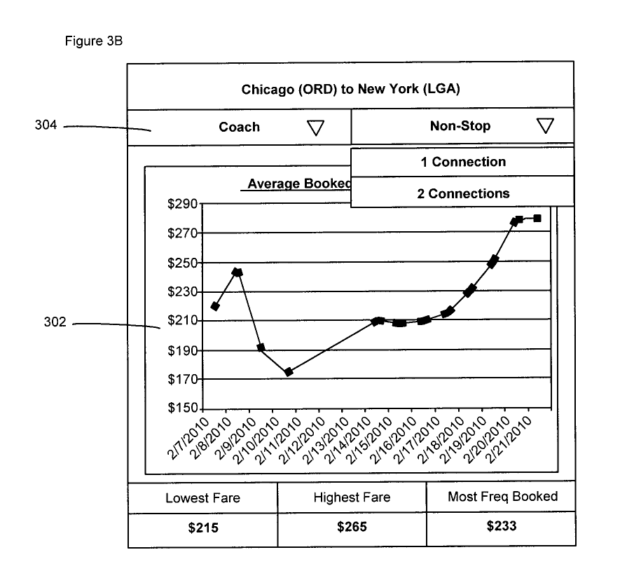

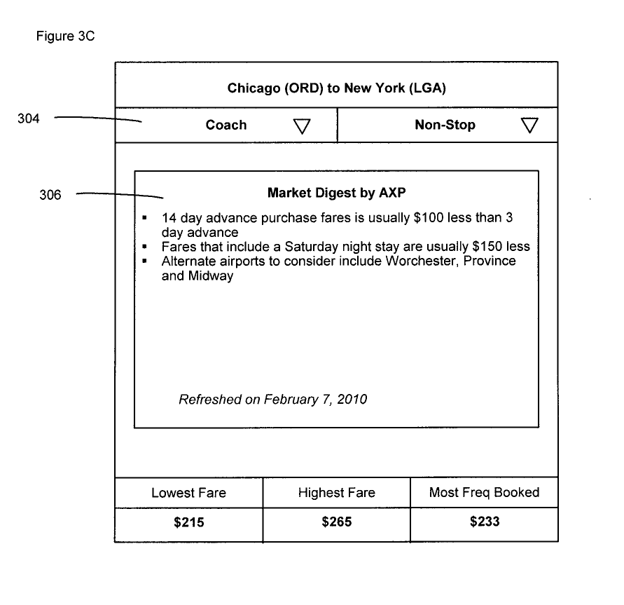

Referring now to FIGS. 2-3C, the process flows and screenshots depicted are merely embodiments and are not intended to limit the scope of the invention as described herein. For example, the steps recited in any of the method or process descriptions may be executed in any order and are not limited to the order presented. It will be appreciated that the following description makes appropriate references not only to the steps and user interface elements depicted in FIGS. 2-3C, but also to the various system components as described above with reference to FIG. 1.

Referring to FIG. 2, a method 200 for generating market insight is described. In an embodiment, a consumer may access a market profile tool (step 202). A market profile tool may comprise a variety of software, including, for example, a web-page, an application or micro-application for use with any of the variety of clients described above, and the like. A consumer may access a market profile tool by way of client 102. In an embodiment, a consumer may access a market profile tool by searching for an item or service on a merchant website with client 102. A consumer may elect to have the assistance of the market profile tool (e.g., by clicking on a market profile tool button), or the consumer may simply receive the assistance of the market profile tool by virtue of the consumer's interaction with the merchant website. In an embodiment, a consumer may interact with the market profile tool by way of a website or interface that is not affiliated with the merchant website. A merchant may generate income from a market profile tool in a variety of ways. For example, a merchant may license a market profile tool to consumers and/or offer a market profile tool for sale based upon a pay-per-click or flat fee arrangement.

In exemplary embodiments, a merchant and/or a consumer may receive a market profile tool for free (e.g., as an incentive to make travel reservations using a particular merchant/travel services website). For example, where client 102 comprises a mobile communication device, a consumer (including an employee of a business) may receive or download an application to his mobile communication device which he may use to open and run a market profile tool.

A consumer may create a market profile request (step 204) in a variety of ways. For example, a consumer may passively create a market profile request by running a search for an item or service on a merchant website and/or by way of a market profile tool. In an embodiment, a consumer may actively make a market profile request by selecting an option to generate a market profile request (e.g., an option displayed via a web-page and/or market profile tool). A consumer may create a market profile request by way of client 102.

In response to receiving a market profile request, server system 106 may generate a market profile (step 206). Server system 106 may generate a market profile based at least partially upon actual purchase data, published pricing data, and/or data related to a specific item and/or market. Actual purchase data may include data related to an actual amount paid by a consumer for an item (e.g., a booked reservation). Published pricing data may comprise data related to a published price of an item (e.g., a published price of a travel ticket). Actual purchase data and/or published pricing data may further comprise a variety of data—e.g., data associated with one or more consumers, data associated with business travelers, data associated with business purchases, and the like.

A market profile may be based upon a variety of historical and/or future data. Historical data may comprise actual purchase data—i.e., purchase prices actually paid by consumers for an item. Historical data may also comprise published pricing data—i.e., prices published by one or more merchants in association with items offered for sale by the one or more merchants. Future data may comprise actual purchase data—i.e., purchase prices actually paid by consumers for an item, where the item will occur (or payment will be made therefore) in the future. Future data may also comprise published pricing data—i.e., prices published by one or more merchants in association with items and/or services offered for sale by the one or more merchants.

In an embodiment, actual purchase data and/or published pricing data may largely comprise (e.g., at least 90%) data associated with business travelers, business purchases, and the like (i.e., data related to business). Where the actual purchase data and/or published pricing data largely comprise business related data, system 100 may be of substantial assistance to business travelers/purchasers, as the needs and purchasing habits of business people are often very different from those of consumers making purchasing/travel decisions for leisure. For example, and as described in additional detail below, an individual making a travel reservation for leisure may reserve a flight on an airline several months in advance, in which event ticket prices are likely to be substantially less expensive than they will be only several weeks prior to the reserved travel date. In contrast, it is common for business travelers to make travel reservations only a week or two in advance of a desired travel date. Thus, a plurality of data associated with leisure travelers may tend to skew a market profile towards an unrealistically low ticket price (i.e., a “false low”). A business traveler searching for tickets using a system that incorporates a large amount of leisure travel data may therefore receive an erroneous or unrealistic market profile. System 100 may remedy this problem by substantially limiting the actual purchase data and/or published pricing data to data associated with business travelers/purchasers.

In an embodiment, client 102 may generate a market profile based upon data received from server system 106 and/or purchase history database 108 (step 206). Thus, data processing (i.e., market profile generation) may be accomplished on a server-side or on a client-side. The actual purchase data and/or published pricing data may be saved in one or more databases coupled to server system 106, such as, for example, purchase history database 108.

A market profile may comprise a variety of information (step 206). For instance, a market profile may show one or more market pricing trends. A market profile may show how the price of an item has changed or will change over time. In other words, a market profile may show historical trends as well as forecast future trends. A market profile may include a variety of other data, including helpful information, suggestions, recommendations, a high, low, and average/median/mean/modal price, and the like.

In an embodiment, a market profile may be based upon data occurring or collected during a period previous to and/or following a selected date. The data used to generate a market profile may be updated in real time or in pseudo-real time (i.e., real time delayed by a small processing interval). Thus, for example, a market profile may be based upon data occurring within a four week window of a selected date—e.g., data occurring within the selected purchase date and two weeks prior to the selected date and two weeks later than the selected date. In an embodiment, any of the data displayed in a market profile may be based upon such a data window. However, in an embodiment, any of a high, low, average, median, mean, and/or modal price may be based upon data occurring in such a window. Analysis of high, low, average, median, mean, and/or modal prices in such a window may facilitate an understanding of short term pricing trends. In an embodiment, a market profile may be based upon data associated with one or more previous years. For example, one or more pricing trends may be based upon data associated with one or more previous years. Pricing trends based upon one or more previous years may be used to identify optimal times to make a purchase. In an embodiment, a market profile may be based upon data associated with a period including a number of months (e.g, four months) preceding a selected date. For example, one or more pricing trends may be based upon data occurring during the four months preceding a selected date. Pricing trends based upon a preceding number of months may assist in determining whether a particular price is in an acceptable or normal range.

Having generated the market profile, in an embodiment, server system 106 may transmit the market profile to client 102 (step 208). Server system may transmit the market profile to client 102 via network 104. Client 102 may display the market profile to a consumer by way of a web-based interface and/or any other interface or display mechanism suitable for displaying a market profile.

In an embodiment, and with reference now to FIGS. 3A and 3B, a market profile associated with an air travel market (i.e., an “air travel market profile”) may be generated by system 100 and method 200. An air travel market profile 302 is shown displayed with an air travel market profile tool 304. The air travel market profile tool 304 may comprise one or more menus, for example, drop down menus. Each menu associated with the air travel market profile tool 304 may be used to manipulate or adjust the air travel market profile 302. Thus, a menu may be used to specify a type of seat (e.g., coach, economy, business class, and/or first class). Likewise, a similar menu may be used to specify a number of connecting flights (e.g., non-stop, 1 connection, 2 connections, etc). A menu (not shown) may be incorporated in air travel market profile tool 304 for selecting a date or date range during which a consumer is interested in traveling. A menu (not shown) may also be provided in air market travel profile tool 304 for selecting one or more city pairs (i.e., an origin city and a destination city). A menu (not shown) may also be provided in air market travel profile tool 304 for selecting one or more airlines with which a consumer is interested in doing business. In an embodiment, a date/date range, one or more city pairs, and/or one or more airlines may not be specified using the air travel market profile tool 304; rather, these criteria may be input by way of a merchant website and provided thereby to air travel market profile tool 304.

With continuing attention to FIGS. 3A and 3B, an air travel market profile 302 may be generated in response to one or more selections made by a consumer using air travel market profile tool 304. A default air travel market profile 302 may also be generated prior to any interaction with air travel market profile tool 304, such as, for example, where a consumer has entered a travel date and city pair in a merchant travel website. An air travel market profile 302 may be generated based at least partially upon the actual purchase data, published pricing data, travel date and city pair, and displayed for the consumer as shown in FIGS. 3A and 3B.

In response to an air travel market profile 302, a consumer may manipulate the one or more menus described above via air travel market profile tool 304 to generate varying air travel market profiles 302 and/or adjust the displayed air travel market profile 302. For instance, a consumer may wish to select coach class and two connections with air travel market profile tool 304. In an embodiment, this action would generate an air travel market profile 304 based upon actual purchase and/or published pricing data associated with air travel tickets of the specified type. Thus, a consumer may utilize air travel market profile tool 304 to manipulate actual purchase and/or published pricing travel data in order to generate a graphical display (air travel market profile 302) of the pricing trends in the air travel market. These pricing trends may be past trends and/or future trends. For example, air travel market profiles 302 may show historical air travel prices, or air travel market profiles 302 may show or forecast future or predicted air travel prices. In an embodiment, air travel market profiles 302 may be based upon actual booked purchase prices associated with flights scheduled in the future. Thus, in an embodiment, air travel market profiles 302 may effectively forecast pricing trends based upon future bookings. This may occur in addition to or as an alternative to air travel market profiles 302 based upon actual booked purchase prices of air fares that occurred in the past and/or published air travel prices that may or may not have been booked.

With continuing attention to FIGS. 3A and 3B, an air travel market profile 302 may be displayed for a consumer in any format that is suitable for that purpose. Thus, for example, air travel market profiles 302 may be displayed as line graphs, bar graphs, pie graphs, and the like. Further, air travel market profiles 302 may include lowest prices, highest prices, average prices (e.g., average of certain tickets that were sold in the past), a price that is most frequently booked, and/or any other data useful for quantifying, summarizing, and/or forecasting pricing trends. In an embodiment, an air travel market profile 302 may scroll across the top/bottom/side of a client display akin, for example, to the manner in which a stock ticker may scroll across the bottom of a client display.

In an embodiment, a consumer may simply click on a date displayed in an air travel market profile 302 in order to locate the least expensive travel ticket (or any item with certain preferred or desired characteristics) currently available for sale on that date. This may be achieved in combination with the use of one or more menus (described above), in which case, a consumer may adjust an air travel market profile 302 to his liking (e.g., coach class, non-stop), and thereafter, select a date upon which he plans to travel. By selecting the date, the consumer may be presented with the least expensive ticket currently available for sale on the selected date that meets the consumer's specified criteria (i.e., coach class, non-stop). In one embodiment, the least expensive ticket may not be available, so the system may locate the average of certain tickets that were sold in the past.

With reference to FIG. 3C, an air travel market profile 302 may further comprise a market digest 306. A market digest 306 may supply a variety of helpful information. For instance, market digest 306 may give suggestions/recommendations and/or provide relevant and/or statistical data, as shown at FIG. 3C. That is, a market digest 306 may display, in an embodiment, an optimal date to purchase tickets, an optimal date to redeem tickets (i.e., an optimal date to travel), an optimal carrier, an optimal city pair, any combination of the foregoing, and the like.

In an embodiment (and as described above with reference to FIG. 2), an air travel market profile 302 may be at least partially based both upon data associated with individual consumers as well as data associated with one or more businesses. However, in an exemplary embodiment, an air travel market profile 302 may be based only upon data associated with individual consumers or data associated with one or more businesses. For instance, where a consumer requests an air travel market profile 302, the profile 302 may be based upon consumer data. Likewise, where a business (or individual associated with a business) requests an air travel market profile 302, the profile may be based upon data associated with one or more businesses. Where the data available for generating an air travel market profile 302 is consolidated between consumer data and business data, consumer and/or business data may be filtered from the consolidated data, depending upon the type of profile 302 requested.

In an embodiment, consumer data may be maintained separately (e.g., in an independent database) from business data. It may be important to separate or filter consumer data from business data, because businesses do not schedule travel in the same way that consumers do. For example, businesses do not typically schedule travel six months prior to an expected travel date. Consumers, on the other hand, often plan vacations and family reunions many months in advance. Thus, from a business' perspective, the prices paid for travel by one or more consumers are not representative of the prices a business may expect to pay when it schedules a trip only several weeks in advance. In other words, from a business' perspective, consumer data may comprise a number of outliers, which may undesirably skew pricing trends towards a false low. Likewise, from a consumer's perspective, business data may undesirably skew pricing trends towards a false high, although a consumer scheduling a trip only several weeks in advance may not realize this outcome.

In an embodiment, a business may wish to limit an employee or ticket purchaser to a particular price. In other words, there may be a price beyond which a business may not wish its employees to spend. In this circumstance, a business may impose a spending limit on one or more employees through air travel market profile tool 304. Thus, where an employee selects a ticket for purchase that is priced outside the employer's maximum range, air travel market profile tool 304 may, through client 102 and/or server 106, prevent the purchase of the unauthorized ticket.

In an embodiment, system 100 and method 200 may generate a market profile associated with a hotel market (i.e., a “hotel market profile”) (not shown). A hotel market profile and profile tool may resemble an air travel market profile and profile tool as described above with reference to FIGS. 3A through 3C, making all necessary and appropriate allowances and adjustments for the subject matter (i.e., hotel pricing data) associated with and represented by the hotel market profile.

Thus, in an embodiment, a hotel market profile may be generated by a hotel market profile tool (not shown) and may comprise one or more menus (not shown), for example, drop down menus. Each menu associated with the hotel market profile tool may be used to manipulate or adjust the hotel market profile. Thus, a menu may be used to specify a type of hotel (e.g., economy, budget, luxury, 1 star, 2 star, 3 star, 4 star, 5 star, and the like). Likewise, a similar menu may be used to specify a length of stay (e.g., 1 night, 2 nights, etc). A menu may be incorporated in a hotel market profile tool for selecting a date or date range during which a consumer is interested in staying in a hotel. A menu may also be provided with a hotel market profile tool for selecting one or more cities and/or locations. A menu may also be provided in a hotel market profile tool for selecting by a consumer one or more hotel chains or merchants with which a consumer is interested in doing business.

Further, as described above with reference to the air travel market profile 302, a consumer may manipulate the one or more described menus to generate varying hotel market profiles and/or adjust a displayed hotel market profile. Thus, a consumer may utilize a hotel market profile tool to manipulate actual booked and/or published hotel pricing data in order to generate a graphical display of the pricing trends in a particular hotel market, and, as above, these pricing trends may be past trends and/or future trends. For example, hotel market profiles may show historical hotel prices. Hotel market profiles may also show or forecast future or predicted hotel prices. Further, in an embodiment, hotel market profiles may be based upon actual booked purchase prices associated with hotel stays scheduled in the future. Thus, hotel market profiles may effectively forecast pricing trends based upon future bookings. This may occur in addition to or as an alternative to hotel market profiles based upon actual booked purchase prices of hotels that occurred in the past and/or published hotel prices that may or may not have been booked.

Further still, a hotel market profile may be displayed for a consumer in any format that is suitable for that purpose. Thus, for example, a hotel market profile may be displayed as a line graph, a bar graph, a pie graph, and the like. Further, a hotel market profile may include a lowest price, a highest price, an average price, a price that is most frequently booked, and/or any other data that may be useful for quantifying, summarizing, and/or forecasting pricing trends. A hotel market profile may scroll across the top/bottom/side of a client display akin, for example, to the manner in which a stock ticker may scroll across the bottom of a client display.

In an embodiment, and similar to the description associated with air travel market profiles, a consumer may simply click on a date displayed in a hotel market profile in order to locate the least expensive hotel rate available for sale on a selected date. Likewise, a hotel market profile may comprise a hotel market digest (not shown). A hotel market digest may supply a variety of helpful information. For instance, a hotel market digest may give suggestions/recommendations and/or provide relevant and/or statistical data. That is, a hotel market digest may display, in an embodiment, an optimal date to purchase a hotel room, an optimal date to stay in a hotel room, an optimal hotel merchant/chain, an optimal city and/or hotel location, any combination of the foregoing, and the like. Further still, a hotel market profile may be based upon consumer and/or business data, as described above with reference to FIGS. 3A through 3C. Additionally, a business may limit an employee to a maximum room rate by way of a hotel market profile tool.

In an embodiment, system 100 and method 200 may generate a market profile associated with a rental market (i.e., a “hotel market profile”) (not shown). A rental market may comprise any market in which items or services are offered for rent. For example, a rental market may comprise a car rental market, a home or apartment rental market, a recreational vehicle rental market, and the like. A rental market profile and profile tool may resemble an air travel market profile and profile tool as described above with reference to FIGS. 3A through 3C, making all necessary and appropriate allowances and adjustments for the subject matter (i.e., rental pricing data) associated with and represented by the hotel market profile.

Thus, a rental market profile may be generated by a rental market profile tool (not shown) and may comprise one or more menus (not shown), for example, drop down menus. Each menu associated with the rental market profile tool may be used to manipulate or adjust the rental market profile. Thus, a menu may be used to specify a type of rental (e.g., economy, budget, luxury, house, apartment, all terrain vehicle (ATV), watercraft, camper, motor home, houseboat, bicycle, and the like). Likewise, a similar menu may be used to specify a rental term (e.g., 1 day, 2 days, 1 week, 6 months, 1 year, etc). A menu may be incorporated in a rental market profile tool for selecting a date or date range during which a consumer is interested in accepting a rental. A menu may also be provided with a rental market profile tool for selecting one or more rental locations. A menu may also be provided in a rental market profile tool for selecting one or more rental proprietorships with which a consumer is interested in doing business.

Further, as described above with reference to the air travel market profile 302, a consumer may manipulate the one or more of the described menus to generate varying rental market profiles and/or adjust a displayed rental market profile. Thus, a consumer may utilize a rental market profile tool to manipulate actual booked and/or published rental pricing data in order to generate a graphical display of the pricing trends in a particular rental market, and, as above, these pricing trends may be past trends and/or future trends. For example, rental market profiles may show historical rental prices. Rental market profiles may also show or forecast future or predicted rental prices. Further, rental market profiles may be based upon actual booked purchase prices associated with rentals scheduled in the future. Thus, rental market profiles may effectively forecast pricing trends based upon future bookings. This may occur in addition to or as an alternative to rental market profiles based upon actual booked purchase prices of rentals that occurred in the past and/or published rental prices that may or may not have been booked.

Further still, a rental market profile may be displayed for a consumer in any format that is suitable for that purpose. Thus, for example, a rental market profile may be displayed as a line graph, a bar graph, a pie graph, and the like. Further, a rental market profile may include a lowest price, a highest price, an average price, a price that is most frequently booked, and/or any other data that may be useful for quantifying, summarizing, and/or forecasting pricing trends. In an embodiment, a rental market profile may scroll across the bottom of a client display akin, for example, to the manner in which a stock ticker may scroll across the top/bottom/side of a client display.

In an embodiment, and similar to the description associated with air travel market profiles, a consumer may simply click on a date displayed in a rental market profile in order to locate the least expensive rental rate available on a selected date. Likewise, a rental market profile may comprise a rental market digest (not shown). A rental market digest may supply a variety of helpful information. For instance, a rental market digest may give suggestions/recommendations and/or provide relevant and/or statistical data. That is, a rental market digest may display an optimal date to rent an item or service, an optimal rental proprietor, an optimal rental location, any combination of the foregoing, and the like. Further still, a rental market profile may be based upon consumer and/or business data, as described above with reference to FIGS. 3A through 3C. Additionally, a business may limit an employee to a maximum rental rate by way of a rental market profile tool.

In an embodiment, system 100 and method 200 may generate a market profile associated with any market, service, and/or item in which a consumer (or beneficiary of the consumer) has interest. For example, a market profile may be generated for items and/or services including, for example, a cup of coffee, dining at a class of restaurant or even a particular restaurant, skydiving, tickets to a sports event, tickets to a concert or show, cable television, dish-based television, cellular service, internet service, doctors, dentists, and, generally, any item or service that consumers purchase. A market profile and profile tool may resemble an air travel market profile and profile tool as described above with reference to FIGS. 3A through 3C, making all necessary and appropriate allowances and adjustments for the subject matter (i.e., item/service pricing data) associated with and represented by the selected market profile.

Thus, in an embodiment, a market profile may be generated by a market profile tool (not shown) and may comprise one or more menus (not shown), for example, drop down menus. Each menu associated with the market profile tool may be used to manipulate or adjust the market profile. Thus, a menu may be used to specify an item and/or service (e.g., a cup of coffee, dining at a class of restaurant or even a particular restaurant, skydiving, tickets to a sports event, tickets to a concert or show, cable television, dish-based television, cellular service, internet service, doctors, dentists, and the like). A menu may be incorporated in a market profile tool for selecting a date or date range during which a consumer is interested in purchasing a selected item and/or service. A menu may also be provided with a market profile tool for selecting one or more locations associated with the item and/or service. A menu may also be provided in a market profile tool for selecting one or more proprietors with which a consumer is interested in doing business.

Further, as described above with reference to the air travel market profile 302, a consumer may manipulate the one or more of the described menus to generate varying market profiles and/or adjust a displayed market profile. Thus, a consumer may utilize a market profile tool to manipulate actual purchase and/or published pricing data in order to generate a graphical display of the pricing trends in a selected market, and, as above, these pricing trends may be past trends and/or future trends. For example, market profiles may show historical prices of an item and/or service. Market profiles may also show or forecast future or predicted prices of items and/or services. Further, in an embodiment, market profiles may be based upon actual purchase prices associated with goods and/or services scheduled in the future. Thus, in an embodiment, market profiles may effectively forecast pricing trends based upon future bookings. This may occur in addition to or as an alternative to rental market profiles based upon actual purchase prices of goods and/or services that occurred in the past and/or published prices that may or may not have been booked.

Further still, a market profile may be displayed for a consumer in any format that is suitable for that purpose. Thus, for example, a market profile may be displayed as a line graph, a bar graph, a pie graph, and the like. Further, a market profile may include a lowest price, a highest price, an average price, a price that is most frequently booked, and/or any other data that may be useful for quantifying, summarizing, and/or forecasting pricing trends. In an embodiment, a market profile may scroll across the bottom of a client display akin, for example, to the manner in which a stock ticker may scroll across the top/bottom/side of a client display.

In an embodiment, and similar to the description associated with air travel market profiles, a consumer may simply click on a date displayed in a market profile in order to locate the least expensive price available on a selected date for a selected item and/or service. Likewise, a market profile may comprise a market digest (not shown). A market digest may supply a variety of helpful information. For instance, a market digest may give suggestions/recommendations and/or provide relevant and/or statistical data. That is, a market digest may display, in an embodiment, an optimal date to purchase an item or service, an optimal merchant, an optimal location to make a purchase, any combination of the foregoing, and the like. Further still, a market profile may be based upon consumer and/or business data, as described above with reference to FIGS. 3A through 3C. Additionally, a business may limit an employee to a maximum purchase price by way of a market profile tool.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in certain embodiments.

In various embodiments, the methods described herein are implemented using the various particular machines described herein. The methods described herein may be implemented using the particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; .a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, 95/98/2000, XP, Vista, 0S2, UNIX, Linux, Solaris, MacOS, etc.) as well as various conventional support software and drivers typically associated with computers. A user may include any individual, business, entity, government organization, software and/or hardware that interact with a system.

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, 0S2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security. Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, machine, hardware, software or business. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the invention has been described as a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method comprising:
generating, by a computer-based system for providing market insight, a market profile based upon actual purchase data comprising future booked purchase data, wherein the market profile includes at least one of a pricing trend, a high price, a low price, an average price, a median price, a mean price, a modal price, a most frequently paid price, an optimal date to make a purchase, an optimal date to redeem a purchase, an optimal merchant from which to purchase, and an optimal location to make a purchase; and
transmitting, by the computer-based system, the market profile to a client.

2. The method of claim 1, further comprising generating, by the computer-based system, the market profile based upon published pricing data.

3. (canceled)

4. The method of claim 1, wherein the actual purchase data occurs within a range comprising two weeks prior to a selected date and two weeks later than the selected date.

5. The method of claim 1, wherein the actual purchase data occurs within a range comprising a selected date and four months preceding the selected date.

6. The method of claim 1, wherein the actual purchase data occurs within a range comprising a selected date and at least one year preceding the selected date.

7. The method of claim 1, further comprising updating, by the computer-based system, the actual purchase data in pseudo-real time.

8. The method of claim 1, wherein the actual purchase data includes data associated with purchases made by a business.

9. The method of claim 1, further comprising determining, by the computer-based system, a least expensive price associated with a particular date, in response to a date selection received by the computer-based system.

10. The method of claim 1, further comprising limiting, by the computer-based system, a purchaser to a maximum purchase price.

11. The method of claim 1, wherein the actual purchase data comprises at least one of: air travel purchase data, hotel purchase data, and rental purchase data.

12. An article of manufacture including a non-transitory, tangible computer readable store medium having instructions stored thereon that, in response to execution by a computer-based system for providing market insight, cause the computer-based system to perform operations comprising:
generating, by the computer-based system, a market profile based upon actual purchase data comprising future booked purchase data, wherein the market profile includes at least one of:
a pricing trend, a high price, a low price, an average price, a median price, a mean price, a modal price, a most frequently paid price, an optimal date to make a purchase, an optimal date to redeem a purchase, an optimal merchant from which to purchase, and an optimal location to make a purchase; and
transmitting, by the computer-based system, the market profile to a client.

13. A system comprising:
a processor for providing market insight;
a tangible, non-transitory memory configured to communicate with the processor,
the tangible, non-transitory memory having instructions stored thereon that, in response to execution by the processor, cause the processor to perform operations comprising:
generating, by the processor, a market profile based upon actual purchase data comprising future booked purchase data, wherein the market profile includes at least one of: a pricing trend, a high price, a low price, an average price, a median price, a mean price, a modal price, a most frequently paid price, an optimal date to make a purchase, an optimal date to redeem a purchase, an optimal merchant from which to purchase, and an optimal location to make a purchase; and
transmitting, by the processor, the market profile to a client.

14. The system of claim 13, further comprising generating, by the processor, the market profile based upon published pricing data.

15. (canceled)

16. The system of claim 13, wherein the actual purchase data occurs within a range comprising two weeks prior to a selected date and two weeks later than the selected date.

17. The system of claim 13, wherein the actual purchase data occurs within a range comprising a selected date and four months preceding the selected date.

18. The system of claim 13, wherein the actual purchase data occurs within a range comprising a selected date and at least one year preceding the selected date,

19. The system of claim 13, further comprising updating, by the processor, the actual purchase data in pseudo-real time.

20. The system of claim 13, wherein the actual purchase data is limited to data associated with purchases made by a business.
